(19) United States
(12) Patent Application Publication
(10) Pub. No.: US 2007/0299864 A1
(43) Pub. Date: Dec. 27, 2007

(54) OBJECT STORAGE SUBSYSTEM COMPUTER PROGRAM

(76) Inventor: Mark Strachan, Thousand Oaks, CA (US)

Correspondence Address: EDWIN TARVER, 16830 Ventura Blvd., SUITE 360, Encino, CA, 91436, US

(21) Appl. No.: 11/766,712

(22) Filed: Jun. 21, 2007

Related U.S. Application Data
(60) Provisional application No. 60/816,024, filed on Jun. 24, 2006.

(51) Int. Cl. G06F 7/00

(52) U.S. Cl. 707/102

(57) ABSTRACT

An object storage subsystem program with federated object storage on multiple computing nodes, which may be added as a component to existing open source platforms. The subsystem program increases programming efficiency by leveraging existing open source solutions, directly integrating with an application development framework, increasing the efficiency of the framework, and allowing other mechanisms to be introduced that ease implementation for large scale enterprise software development. The program also provides an object storage subsystem with multiple modes of operation to provide high availability and fault tolerant object storage, as well as the capability to manage a massive amount of data across multiple computing nodes with features that enable it to store data on hard drives, clean up unused data, isolate and manage transactions, and provide communication between storage nodes.

### CROSS-REFERENCE TO RELATED APPLICATIONS

None

This application claims the benefit of the priority date of provisional application No. 60/816,024, filed on Jun. 21, 2006.

### FEDERALLY SPONSORED RESEARCH

Not Applicable

### SEQUENCE LISTING OR PROGRAM

Not Applicable

### SUMMARY

The present invention pertains to the field of computerized database management, and more particularly, to an object storage subsystem designed for integration into an open source database platform. Currently, there are no known object management systems that integrate with open source database platforms. Some stand alone products exist such as gemstone OODB and Versant Object Database; which comprise commercial stand alone object persistence solutions. Other open source object database programs such as Ozone DB also exist, but without an object management systems.

It is therefore an object of the present invention to introduce increased programming efficiency similar to object databases to applications by leveraging existing open source solutions. Another object of the present invention is to directly integrate with an application development framework, increasing the efficiency of the framework, and allowing other mechanisms to be introduced that ease implementation for large scale enterprise software development. A further object of the present invention is to provide an object storage subsystem that has multiple modes of operation that provide high availability and fault tolerant object storage, as well as the capability to manage a massive amount of data across multiple computing nodes. Finally, it is an object of the present invention to provide an object storage subsystem with features that enable it to store data on hard drives, clean up unused data, isolate and manage transactions, and provide communication between storage nodes. These and other objects are detailed in the following description and appended illustrations.

### FIGURES

FIG. 1 is a diagram of the object storage subsystem of the present invention in data federation mode, wherein objects are stored on several computing nodes across a network

FIG. 2 is a diagram of the five modules of the object storage subsystem of the present invention.

FIG. 3 is a diagram of the overall object storage subsystem of the present invention, including the five modules and nodes on which data is stored, indicating the roles of each component.

### DETAILED DESCRIPTION

The object storage subsystem (OSS) of the present invention presents a system for storing objects; small stand-alone software programs containing both data and functional algorithms, in a locally available network. Overall, the OSS can operate in two modes; data mirroring mode, and data federation mode. Data mirroring mode uses multiple stand alone computing nodes to store multiple copies of the same data. This affords the data mirroring mode high availability, because the data may be retrieved from multiple sources, and high fault tolerance, since the data is stored in multiple locations.

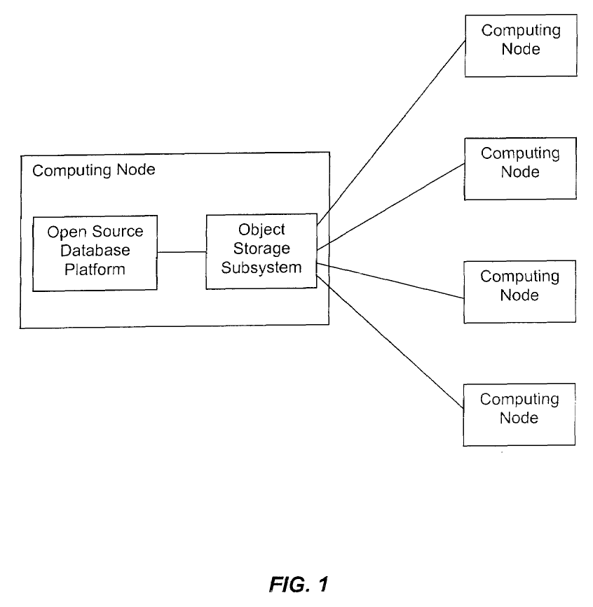

Referring to FIG. 1, the data federation mode confers the ability to manage large quantities of data. In data federation mode the OSS stores data on multiple computing nodes, wherein each node stores an independent set of data. The data contained in the computing nodes is organized through the OSS which may be accessed by an open source database platform.

An important aspect of the relationship of the data between nodes, is that requests for information from any individual node may simultaneously make requests to other data nodes in the system based on functional algorithms contained in the data of the original node to retrieve data that is not present in the original node. The OSS allows data from all nodes to be used as one monolithic data representation from all points in the distributed system.

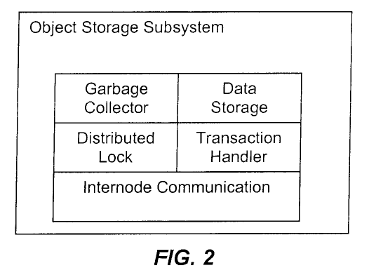

Referring to FIG. 2, The OSS of the present invention contains five modules for performing the following tasks: Module One is a subsystem that allows the OSS to store data on the hard drive of a given node. Module Two is a garbage collection mechanism, used to clean up unused data. By reclaiming unused data, performance improves and computing resources are increased. Module Three is a Distributed Lock mechanism required for isolation of transactions within the OSS. The module comprises a subsystem for providing communication between nodes. Each of the subsystems may be configured according to an individual domain requirement.

The data storage module enables the OSS to store data on the nodes of the system. The OSS allows the system to continue operating in spite of any individual failed operation that may occur. This is possible because the Module can renew the ID Table using data stored in Storage files. All of the objects in the system are stored as Storage files, capable of compression if necessary, and reside on the various nodes of the system. There is parameter allowing the number of objects to be set, which can be stored in single Storage file.

A second type of file, known as an ID Table is used to store data about the location of objects relative to storage files on computing nodes, along with state information about the objects. By accessing the ID Table, the OSS has fast access to objects, which improves efficiency. The ID Table file also contains information about links to the object. OSS provides such information every time when any object is being put, updated or removed from storage. When an object is considered obsolete by the garbage collector module, the object and the data comprising it can be automatically deleted from the system.

The garbage collector module periodically checks the ID Table to locate objects and data that are no longer linked to any other objects, and therefore have fallen out of transitive closure in the dataset. Transitive closure is, from the root node of a dataset, all objects that can be reached by traversing the graph of object references. Since these objects will no longer be used by the program, they may be deleted from the database. In addition, any storage files that have a small number of objects may be consolidated.

The frequency of garbage collection, and the number of objects within a file are controlled by parameters within the garbage collector.

The transaction isolation module (provided by an open source database) sets locks against objects involved in a transaction, and the Distributed Lock distributes these locks across the nodes of the network. This allows the OSS to manage transactions. First the Distributed Lock tries to lock the required object on the node where the object is located. If the object has been locked successfully, the Distributed Lock sends to all other nodes the message with information about locked object. On each node the Distributed Lock, after receiving this information, provides a lock for the object even if the object doesn't reside in that node.

The transaction handler module receives messages regarding “commit” and “rollback.” Commit commands indicate that a transaction within the network is to be completed, whereas a rollback command indicates that a transaction should be reversed so that it appears to have never occurred. The transaction handler module distributes these messages between nodes and executes a commit or rollback command by sending the appropriate data to the data storage module. The data storage module then makes changes to the ID Table regarding objects, and makes changes to the files containing those objects.

The internode communication module enables the system to use different communication protocols. In a preferred embodiment, the implementation uses JGroups over TCP/IP. The communication module is used by the transaction isolation module and the transaction management module to allow communication between nodes.

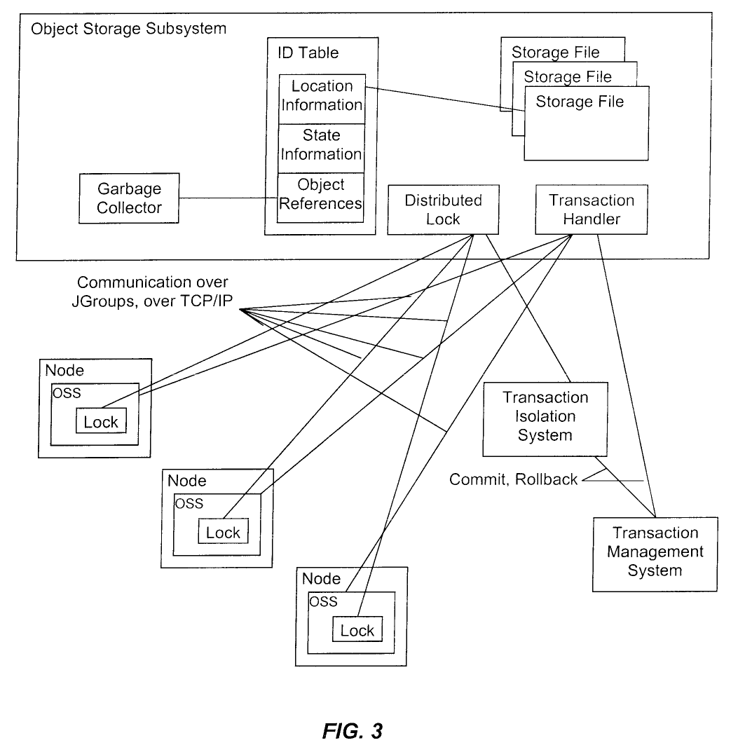

Referring to FIG. 3, an overview of the connection between the modules of the OSS demonstrates how the modules nodes and OSS are interconnected. Objects are stored on various nodes in a network, each node containing a lock corresponding to the object. A lock is a flag for an object that prevents it from being modified by anything other than the holder of the lock. Each node is connected (by the Distributed Lock) to the transaction isolation module, which maintains the lock system over the objects. In one preferred embodiment, communication between the transaction isolation module and the nodes is accomplished via JGroups, over TCP/IP.

The transaction isolation system (using the Distributed Lock) is in contact with the transaction management system, which receives and sends commit and rollback commands between the object storage subsystem and the nodes (by the transaction handler), allowing changes to be made to the objects and data.

The transaction management system communicates with the main object storage subsystem, which maintains the storage files for the objects, the ID Table. The ID Table contains information regarding the storage files, including location information, object state information (this indicates whether the proxy for object is still used by client), and object references. The garbage collector module monitors the object references and deletes obsolete objects and data, improving the performance and efficiency of the system.

The present invention clusters objects and conducts transaction management in a manner to increase operational efficiency. In the current art, objects are joined into so-called clusters. Each cluster is stored in one file on the file system of an OS. At run time, the size of cluster (the quantity of objects which can be contained in one cluster) is fixed and is defined by parameters described in the system configuration file before the system has been started. When a client application creates a new object and stores it in a database, the system assigns an ID for the object and stores the object in the first cluster with a current quantity of contained objects less than the number of contained objects defined by configuration parameter. A client application can call the object by its ID or its name. If the object has name, this name is stored in special file called Name Table where the object's ID is stored by the object's name. When the client application calls for the object by its name, the system finds the object ID in this table.

At run time, if the client application calls an object, the system (using the object ID) finds the appropriate cluster and reads the object from there. After the object has been changed the client (by executing the appropriate call) the system puts it in the DB and the system stores it in the cluster where the object was contained before. If the client application used a number of objects in one transaction—which occurs frequently—each used object will be restored in its own cluster. When the system loads the called object it loads the cluster containing this object. Therefore, if the transaction locks the object, all clusters containing the required object are also locked. This scheme has the following disadvantage: In the event two different objects stored in one cluster should be used in two different transactions; one of the transactions will be blocked as long as the other one has not been committed. This scenario can be represented by the following equation:

T=Tt1+Tt2

Where T is the time spent for executing two transactions t1 and t2, Tt1 is the time spent for executing transaction t1 and Tt2 is the time spent for executing transaction t2. This is true because t2 will be blocked as long as t2 is not committed. This type of storage mechanism is ineffective and results in lower productivity.

By comparison, the present invention provides a more effective method of storing data. In the present invention, objects in storage are grouped in clusters, however each cluster contains objects which have been stored in one transaction when the transaction is being committed. Therefore, when a client application calls an object, the system loads the cluster containing the object. However, the system doesn't lock the loaded cluster. Instead, the system stores all objects contained in the loaded cluster in an object cache, with required objects locked per transaction. When a transaction is being committed, all the objects used in it are grouped in one cluster and this cluster is stored in a new file in file system of the OS. Then system then provides appropriate changes in an ID Table file where the current location of object is stored by object ID. Using this scheme, clusters that do not contain actual objects are deleted. Furthermore clusters that contain a small number of objects are re-grouped into clusters containing a more appropriate number of objects. This improved system can be represented by the equation:

T=max(Tt1,Tt2)<T=Tt1+Tt2

where T, t1, t2, Tt1 and Tt2 are the same as in the first equation. In the present invention, the ID Table is not simply a map where object locations are stored by their respective IDs. Rather, when an object is stored, information regarding all references to other relevant objects is provided. This information is useful for other purposes as well, such as garbage collecting.

The present invention also provides a novel disk storage system and system optimization feature. In the present art, when objects are saved onto disk, the processor's time is spent not only for writing the object's data, but also for “overhead expenses.” Overhead expenses are of two kinds; expenses for file creation and opening, and expenses for finding old instances of an object within a file to overwrite it. If all objects are stored in one file, the expense for file creation and opening is minimal, but the expense for finding the object is increased. By contrast, if each object is stored in separate file, the expense for finding an object will be minimal but the expense for creating and opening the file will be greater.

In systems currently available in the marketplace, all objects stored in a database are grouped into clusters, and each cluster is stored in a separate file. The size of a cluster is fixed (by configuration parameters) and objects are added to the cluster until its size limit is reached. This scheme has several shortcomings: In some cases, when a transaction is committed, saved objects can be placed in different clusters (potentially with the number of objects equal to the number of clusters). Furthermore, object locks (used for transaction isolation) are not based on objects but rather on clusters (for instance row-locking and page-locking in RDBMS) which leads to unnecessary transaction blocking.

To minimize overhead expenses and to eliminate shortcomings currently in the art, the present invention modifies objects within one transaction and groups them in one cluster. They are then stored in one file. In addition to eliminating the above problems, this scheme of object grouping has some additional advantages: It eliminates the needs to synchronize data storing from different transactions; and it allows the system to use load-ahead cache population with a high successful rate (based on combined use of objects). When a transaction is being completed, all domain objects modified in the transaction are stored in one file. For each domain object the system creates a utility object—ContainerLocation. This object contains information about the name of a file that contains a given object, a list of other objects the given object is referring to, and other info. The ContainerLocations are put into an ID Table, which contains pairs of object ID and ContainerLocation for each object. Therefore, the ID Table contains the location of the last version of each object. Moreover the ID Table monitors the number of active objects located in a cluster and deletes the cluster if it fails to contain any active objects.

What is claimed is:

1. An object storage subsystem, comprising a system for storing objects, comprising small stand-alone software programs containing both data and functional algorithms, in a locally available network.

2. The subsystem of claim 1, wherein the subsystem can operate in two modes; data mirroring mode, and data federation mode, wherein data mirroring mode uses multiple stand alone computing nodes to store multiple copies of the same data, and data may be retrieved from multiple sources.

3. The subsystem of claim 1, wherein the subsystem can be accessed by an open source database platform.

4. The subsystem of claim 1, wherein requests for information from any individual node may simultaneously make requests to other data nodes in the system based on functional algorithms contained in the data of the original node to retrieve data not present in the original node, and wherein the subsystem allows data from all nodes to be used as one monolithic data representation from all points in the distributed system.

5. The subsystem of claim 1, wherein the subsystem contains modules for performing the following tasks;
a. module one, a subsystem that allows the subsystem to store data on the hard drive of a given node;
b. module two, a garbage collection mechanism, used to clean up unused data to improve performance and free computing resources;
c. module three, a distributed lock mechanism required for isolation of transactions within the subsystem, the distributed lock mechanism comprising a subsystem for providing communication between nodes.

6. The subsystem of claim 5, wherein each of the subsystems may be configured according to an individual domain requirement.

7. The subsystem of claim 5, wherein the data storage module enables the subsystem to store data on the nodes of the system and continue operating in spite of any individual failed operation that may occur.

8. The subsystem of claim 7, wherein the data storage module can renew an ID table using data stored in storage files, and all of the objects in the system are stored as storage files, capable of compression if necessary, and residing on the various nodes of the system, with a parameter allowing the number of objects to be set, which can be stored in single Storage file.

9. The subsystem of claim 8, wherein a type of file, known as an ID table is used to store data about the location of objects relative to storage files on computing nodes, along with state information about the objects, wherein by accessing the ID Table, the subsystem has fast access to objects, which improves efficiency, the ID Table file contains information about links to an object, and the subsystem provides such information every time any object is being stored, updated or removed from storage; and when an object is considered obsolete by the garbage collector module, the object and the data comprising it can be automatically deleted from the system.

10. The subsystem of claim 5, wherein the garbage collector module periodically checks the ID table to locate objects and data that are no longer linked to any other objects, and therefore have fallen out of transitive closure in the dataset; and transitive closure is, from the root node of a dataset, all objects that can be reached by traversing the graph of object references.

11. The subsystem of claim 10, wherein the frequency of garbage collection and the number of objects within a file are controlled by parameters within the garbage collector.

12. The subsystem of claim 5, wherein module 3, the transaction isolation module sets locks against objects involved in a transaction, and the distributed lock distributes these locks across the nodes of the network.

13. The subsystem of claim 12, wherein first the distributed lock tries to lock the required object on the node where the object is located. If the object has been locked successfully, the distributed lock sends to all other nodes the message with information about locked object; wherein on each node, the distributed lock, after receiving this information, provides a lock for the object even if the object doesn't reside in that node.

14. The subsystem of claim 1, wherein a transaction handler module receives messages regarding “commit” and “rollback”; wherein commit commands indicate that a transaction within the network is to be completed, whereas a rollback command indicates that a transaction should be reversed so that it appears to have never occurred, and the transaction handler module distributes these messages between nodes and executes a commit or rollback command by sending the appropriate data to the data storage module; and the data storage module then makes changes to the ID Table regarding objects, and makes changes to the files containing those objects.

15. The subsystem of claim 1, wherein an inter-node communication module enables the system to use different communication protocols.

16. The subsystem of claim 15, wherein the implementation uses JGroups over TCP/IP, and the communication module is used by the transaction isolation module and the transaction management module to allow communication between nodes.
